(19) United States
(12) Patent Application Publication
(10) Pub. No.: US 2011/0126838 A1
(43) Pub. Date: Jun. 2, 2011

(54) RESPIRATORY NASAL MASK WITH PIVOTABLE ARM FOR HOLDING AND ORIENTATING THE FOREHEAD SUPPORT

(75) Inventors: Luca Alberici, Brescia (IT); Alberto Rivetti, Rovato (IT); Giuseppe Sandoni, Brescia (IT)

(73) Assignee: Air Liquide Medical Systems, Antony (FR)

(21) Appl. No.: 12/947,281

(22) Filed: Nov. 16, 2010

(30) Foreign Application Priority Data
Dec. 2, 2009 (EP) 09177728.4

(51) Int. Cl. A62B 18/08

(52) U.S. Cl. 128/207.11

(57) ABSTRACT

A respiratory mask, in particular a nasal mask, comprising a mask body (1) with an internal chamber (10), an expansion part (2) being arranged on the mask body (1) and projecting upwardly from said mask body (1), said expansion part (2) comprising a traversing orifice (3), a holding arm (4) pivotable around a first axis (AA) located on said mask body (1) or on said expansion part (2), a forehead support (9) fixed to said holding arm (4) and pivotable around an axis (BB) located on said holding arm (4), and an acting piece (5) mobile in said traversing orifice (3), wherein the acting piece (5) cooperates with the holding arm (4) for pivoting said holding arm (4) around the first axis (AA) when said acting piece (5) moves in the traversing orifice (3) of the expansion part (2). The mask of the present invention is useable for treating sleep disordered breathing (SDB) conditions, such as, for example, obstructive sleep apnea.

### CROSS REFERENCE TO RELATED APPLICATION

This application claims the benefit of priority under 35 U.S.C. §119 (a) and (b) to European Application No. 09177728.4, filed Dec. 2, 2009, the entire contents of which are incorporated herein by reference.

### FIELD OF THE INVENTION

The present invention concerns a respiratory mask with a pivotable forehead support, in particular a nasal mask, for use in the treatment of respiratory conditions or diseases, such as obstructive sleep apnea. The respiratory mask comprises a mechanism for pivoting the forehead support with respect to the mask body.

### BACKGROUND

Nasal masks are commonly used for delivering non-invasive positive pressure ventilation (NPPV) or for nasal continuous positive airway pressure (N-CPAP) therapy in sleep disordered breathing (SDB) conditions, such as obstructive sleep apnea (OSA).

Nasal masks deliver a flow of breathable gas for, or to assist in, patient respiration, especially during the night, i.e., when the patient is sleeping.

Such a mask assembly typically comprises a rigid or semi-rigid hollow shell defining a breathing chamber that receives at least a part of the patient's nose and further comprising a soft face-contacting cushion that comes into contact with the patient's face, and a forehead support and a headgear for correctly positioning, maintaining and/or securing the mask on the head of a patient.

The forehead support is usually arranged on an expansion part of the mask, i.e., a portion of the mask body forming a holding arm that projects upwardly from the mask body and in the direction of the forehead of the user when the mask is positioned on the user's face. An example of a nasal mask of this kind is given by EP-A-462701.

The shell typically receives a gas supply line which delivers a respiratory gas, such as air under pressure, into the breathing chamber of the shell. Further, the soft face-contacting cushion can be made of a soft, resilient elastomeric material that may conform to the various facial contours of the patient face.

The mask assembly is secured to the wearer's head by straps or similar devices thereby forming a headgear that can be adjusted to pull the mask against the face with sufficient force to achieve a gas tight seal between the mask and the wearer's face as taught by EP-A-462701, EP-A-874667, EP-A-1972357 or WO-A-00/57942.

However, with the current masks, it is often difficult to obtain an efficient positioning of the mask on the patient's face and to ensure sufficient tightness (seal) preventing the escape of gas as well as a comfort of use for the patient. In particular, as the morphology of the face is different from one user to another, it is important to be able to correctly position the forehead support of the mask on the user's forehead and afterwards maintain it in a desired position, whatever the forehead morphology of the patient is.

For instance, some masks including various mechanisms for positioning the forehead support are disclosed by U.S. Pat. No. 2,245,658, EP-A-1985327 and EP-A-1356842.

However, so far, while attempts for modifying the existing positioning mechanisms have been made, the resulting masks are not totally satisfying.

Hence, the problem to be solved is to provide an improved mask architecture allowing an easy and efficient angular positioning of the forehead support with respect to the mask body so as to ensure efficient gas tightness (seal) and/or increase comfort for the user.

### SUMMARY OF THE INVENTION

The solution provided by the present invention concerns a respiratory mask, in particular a nasal mask, that comprises a mask body with an internal chamber, an expansion part being arranged on the mask body and projecting upwardly from said mask body, the expansion part comprising a traversing orifice, a holding arm pivotable around a first axis AA located on the mask body or on the expansion part, a forehead support fixed to the holding arm and pivotable around an axis BB located on the holding arm, and an acting piece mobile in the aid traversing orifice, wherein the acting piece cooperates with the holding arm for pivoting the holding arm around the first axis AA when the acting piece moves in the traversing orifice of the expansion part.

### BRIEF DESCRIPTION OF THE FIGURES

A preferred embodiment of a nasal mask according to the present invention is shown in the enclosed figures.

FIG. 1 represents a nasal mask according to the present invention.

FIG. 2 is a disassembled view of the mask of FIG. 1.

FIG. 3 shows the angular courses of the holding arm and the forehead support.

FIGS. 4a and 4b illustrate a forward motion of the acting piece of the mask of FIG. 1.

FIG. 5 shows the rotative knob of the mask of FIG. 1.

FIG. 6 represents a enlarged with of the threading of the acting piece of the mask of FIG. 1.

### DETAILED DESCRIPTION OF THE INVENTION

The present invention provides an improved mask that allows easy and efficient angular positioning of the forehead support with respect to the mask body in order to ensure efficient gas tightness (seal) and/or increase comfort for the user. The respiratory mask, in particular a nasal mask, comprises a mask body with an internal chamber, an expansion part being arranged on the mask body and projecting upwardly from the mask body, the expansion part comprising a traversing orifice, the expansion part and the mask body being molded in one-piece so that the expansion part is integral with the mask body, wherein the mask further comprises a holding arm pivotable around a first axis (AA) located on the mask body or on the expansion part, a forehead support fixed to the holding arm and pivotable around an axis (BB) located on the holding arm, and an acting piece mobile in the traversing orifice of the expansion part, wherein the acting piece cooperates with the holding arm for pivoting the holding arm around the first axis (AA) when the acting piece moves in the traversing orifice of the expansion part.

The mask according to the present invention can further comprise one or more of the following additional features:
the mask further comprises a rotating knob cooperating with the acting piece for moving the acting piece in the traversing orifice when the rotating knob is operated by a user.
the holding arm is fixed to the expansion part and pivotable around a first axis AA located on the expansion part.
the acting piece acts on the holding arm for changing its angular position around the first axis AA.
the forehead support pivots around a second axis BB arranged on the holding arm.
the rotating knob comprises a first threading cooperating with a second threading arranged on the acting piece.
the holding arm pivots around the first axis AA of 50° or less.
the forehead support pivots around the second axis BB of 90° or less.
the expansion part is integral with the mask body, preferably the expansion part (2) and the mask body (1) are molded in one piece.
the forehead support comprises one or several pillows of soft material.
the mask body further comprises a gas inlet orifice in fluid communication with the internal chamber, the internal chamber further comprising a peripheral border and a cushion being fixed to the peripheral border, the cushion having a central aperture for receiving at least part of the patient's nose.
the cushion arranged on the peripheral border of the internal chamber comprises one or several flexible membranes.
the threading of the acting piece comprises a restriction.
the mask further comprises a headgear and fixing means for fixing the headgear to the mask body.
a mobile closing flap is connected to the shell and is able to move between at least a first position wherein the mobile closing flap is, at least partially, covering the lodging, and a second position wherein the mobile closing flap is not covering the lodging. The closing flap is mobile in rotation or is pivoting around a connecting element. The axis of the oxygen port is parallel to the axis of the gas inlet orifice of the shell. The oxygen port comprises a main hollow body with a central hollow passage linking an oxygen inlet situated in the lodging to an oxygen outlet situated in the breathing chamber. The lodging is situated in the upper part of the shell between the gas inlet orifice and a front support integral with the shell. The shell, the oxygen port and the lodging are molded in one piece. The closing flap is made of a unique piece of plastic, silicone or any other polymeric or elastomeric material. The lodging is arranged in the shell wall so as to project toward the internal chamber.

For further understanding of the nature and scope of the invention, the present invention will be further described with regard to the detailed description, in conjunction with the accompanying figures, in which like elements are given the same or analogous reference numbers.

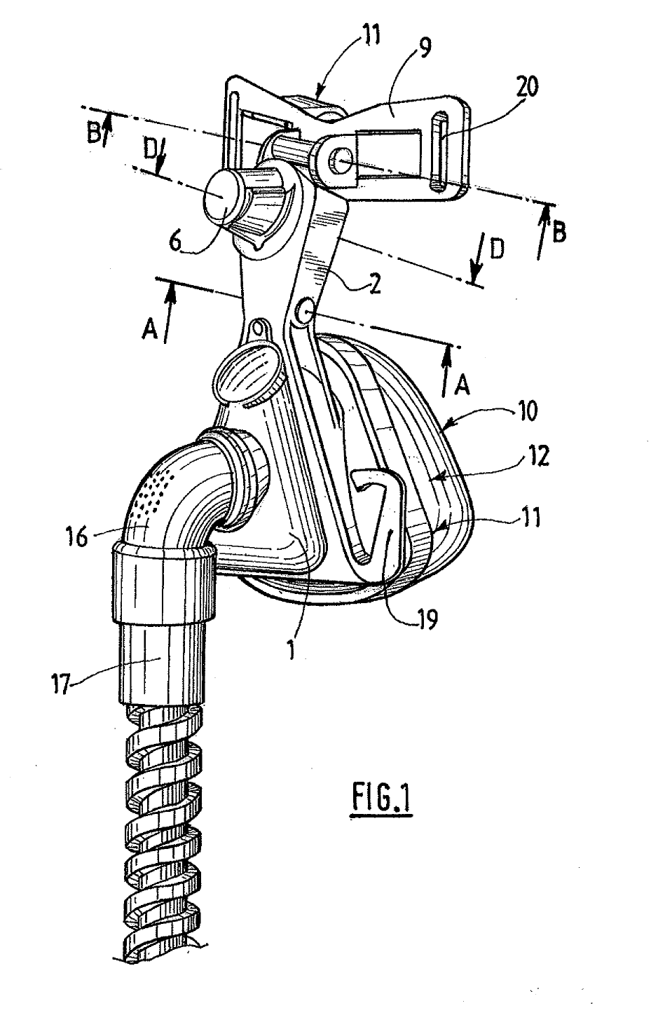

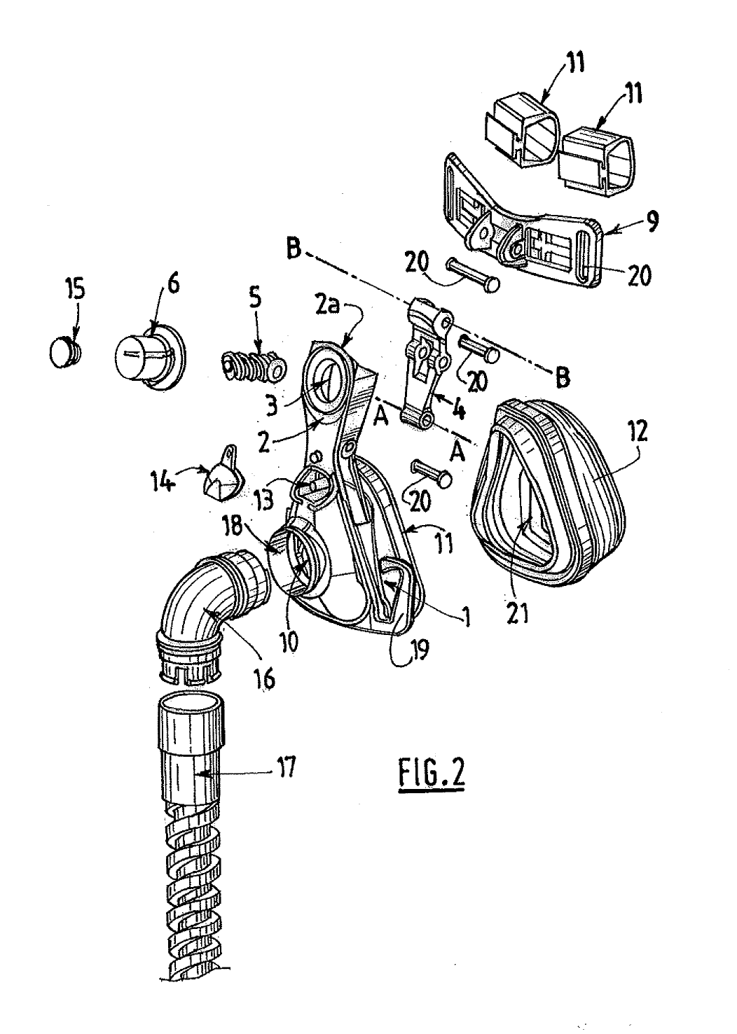

As illustrated in FIGS. 1 and 2, a respiratory mask according to the present invention comprises a rigid or semi-rigid hollow shell or mask body 1 defining an internal breathing chamber 10 or volume, wherein respiratory gas, such as air under pressure, is introduced via an inlet port 18 to which is connected a gas feeding line 17 by means of a tubular connector 16. The gas inlet orifice 18 is arranged at the center of the mask body 1 and through its wall thereby allowing air during pressure to be introduced in the breathing chamber 10.

The mask body 1 is preferably made of a polymer material, such as polycarbonate (PC), polypropylene (PP), ABS, nylon or polystyrene (PS), and is configured so as to be able to receive at least a part of the patient's nose. In other words, the patient introduces his/her nose into the internal volume of the breathing chamber 10 of the mask body 1 and breathes the pressurized gas contained therein. The mask body 1 preferably has a general triangular tridimensional shape as visible in FIG. 1 for example.

The mask body 1 further comprises an expansion part 2 arranged on the top of the mask body 1 and projecting upwardly from the mask body 1, i.e., projecting away from the external surface of the mask body 1. The expansion part 2 comprises a traversing orifice 3, preferably located at its distal end 2a. Preferably, the mask body 1 and the expansion 2 are made of polymeric material that is molded in one piece so as to obtain an expansion part 2 that is integral with the mask body 1.

Furthermore, a forehead support 9 is connected to the mask body 1 by means of a pivotable holding arm 4, i.e., an arm 4 that is mobile in rotation, around a first axis AA situated either on the mask body 1 or on an expansion part 2, preferably on the expansion part 2. The forehead support 9 can comprise one or several pillows 11 of soft and comfortable material.

According to the present invention, an acting piece 5 is arranged in the traversing orifice 3 of the expansion part 2 and is mobile, preferably in translation, in the traversing orifice 3.

More precisely, the acting piece 5 cooperates with the holding arm 4 for pivoting the holding arm 4 around the first axis AA when the acting piece 5 moves in the traversing orifice 3 of the expansion part 2. Further, the forehead support 9 also pivots around a second axis BB arranged on the holding arm 4.

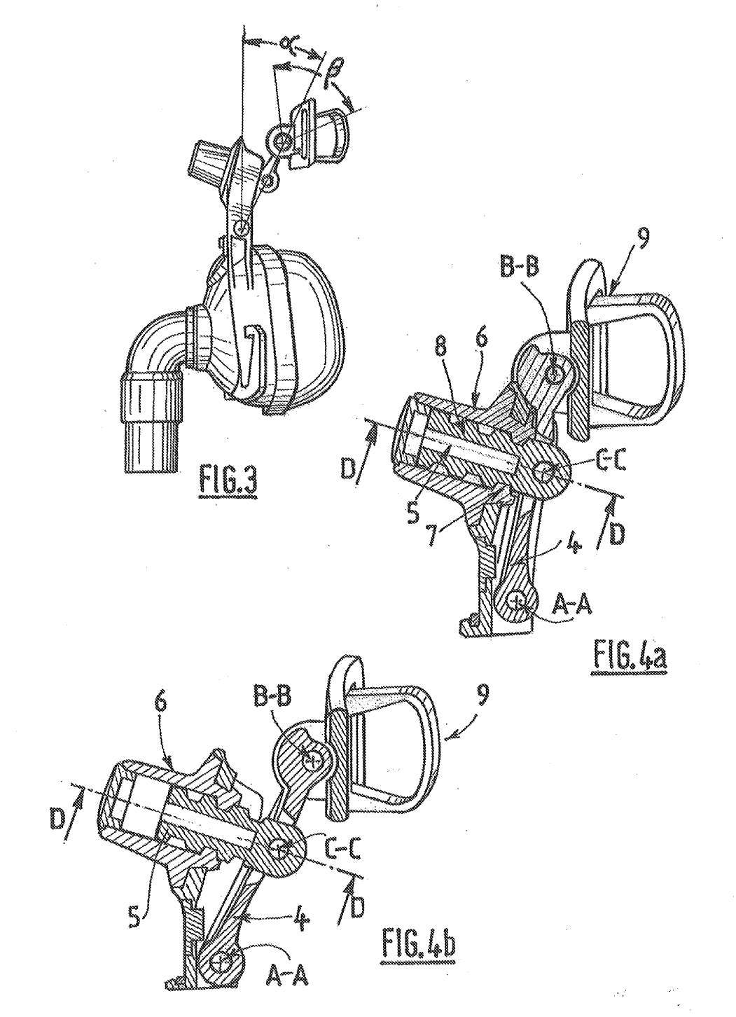

When a user acts on the acting piece 5 and moves it in the traversing orifice 3, the acting piece 5 acts on the holding arm 4 for changing its angular positioning of an angle α of preferably between 0 and 60°, as illustrated in FIG. 3, thereby either approaching the support 9 to the forehead of the user, when the mask is carried by the user, or changing the pressure applied by the mask on the upper part of the nose of the user, when the forehead support 9 is already in contact with the forehead of the patient.

The angular orientation (angle β) of the forehead support 9 can be modified as it is freely pivoted around the second axis BB, thereby automatically matching the shape of the patient's forehead. For obtaining a correct orientation of the support 9 with respect to the patient's forehead, the support 9 should be able to pivot at an angle β of from between 0 and 90°. The possibility of orienting the forehead support 9 and of changing the angular positioning of the holding arm 4 allows obtaining a correct orientation and positioning of the forehead support 2 carried by the holding arm 2, whatever is the morphology of the face of the user.

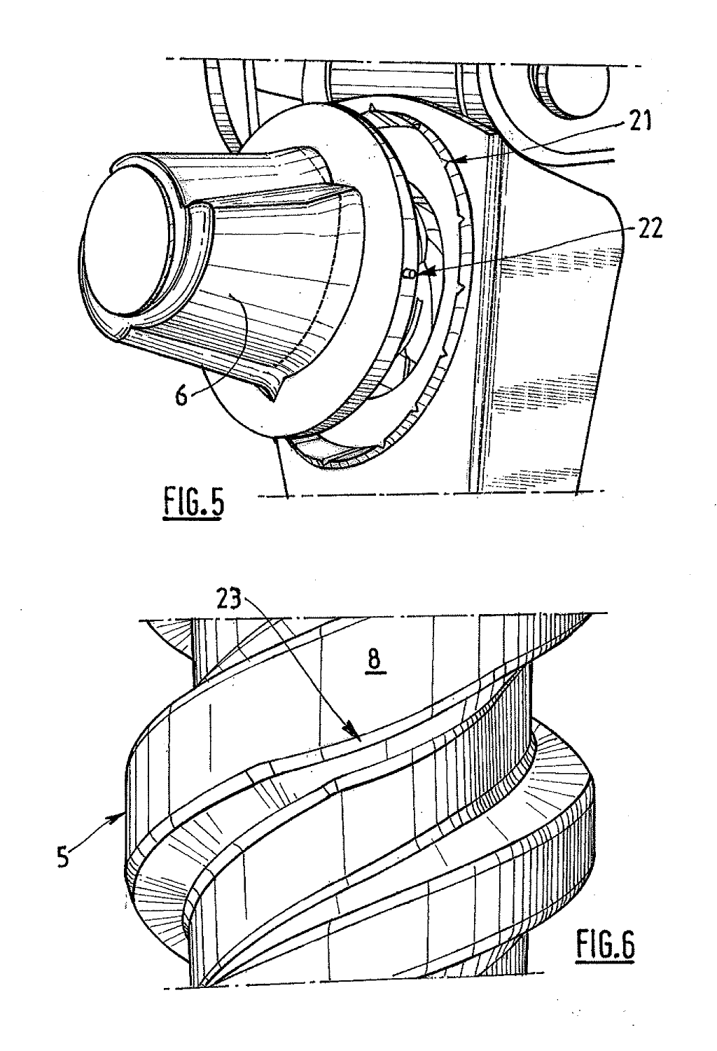

Actually, the back or forward motion of the acting piece 5 in the traversing orifice 3 is obtained by rotation of a rotating knob 6 cooperating with the acting piece 5, when the rotating knob 6 is manually operated by the user. For instance, in FIG. 4a and FIG. 4b, the forward motion of the acting piece 5 has been illustrated. As one can see in FIG. 4a and FIG. 4b, the rotating knob 6 of axis DD comprises a first internal threading 7 that cooperates with a second external threading 8 arranged on the external surface of the acting piece 5. As visible in FIG. 5, several notches 21 are arranged in the periphery of the traversing orifice 3 of the expansion part 2, whereas one (or several) pin 22 is arranged on the periphery of the rotating knob 6 and cooperates with the notches 21 for selecting the angular position of the holding arm 4. Indeed, each notch 21 corresponds to an angular position of the holding arm 4 and two successive notches 21 are spaced apart of a given distance corresponding to a given angle, for instance 10°. Hence, when the user turns the knob 6, the pin 22 is positioned in a given notch 21 corresponding to the desired angular position, and holds the knob 6 is the position. The maximum course of the knob 6 is about 360° or less around its axis DD in the anti-clockwise way.

As shown in FIG. 6, the threading 8 of the acting piece 5 comprises a restriction 23 so as to block the rotation of the knob 6 by the user, when the start or the end of its course is close, i.e., at the beginning or at the end of the motion of rotation.

Furthermore, in order to ensure a tight positioning of the nasal mask on the patient's face and to increase the comfort for the patient, the peripheral border or edge 11 of the mask body 1 comprises a cushion 12 made of soft, resilient, elastomeric material that comes into contact with the patient's face. The cushion 12 has a central aperture 21 for receiving at least a part of the patient's nose. More precisely, the border 11 and the cushion 12 have a general triangular or saddle-shape structure so as to match the contours of the nasal region of the patient and hence the cushion 12 comprises, roughly speaking, an upper nasal bridge region, a lower region and cheek regions connecting the nasal bridge and lower regions. The cushion 4 can comprise one or several membranes, preferably two membranes. Such cushion 4 and mask body 1 structures are well-known in the art and taught by many documents, such as, for example, EP-A-1334742, EP-A-264772, EP-A-956069, EP-A-874667, U.S. Pat. No. 2,931,356 or EP-A-1479406.

A headgear with straps (not shown) can be connected to the mask body 1, by fixing means 19, 20, such as fixing hooks 19 and fixing slots 20, for fixing the straps of the headgear and thereby maintaining the mask in the selected position on the head of the patient during its use and thus obtaining an efficient treatment of sleep disorders, such as OSA or similar disorders. The headgear-fixing hooks 19 are fixed and made integral with the shell 1 body. Preferably, the headgear-fixing hooks 19 are flat parallel portions, but of course, the headgear-fixing hooks 19 can have other forms. Such a mask structure is also well known in the art and disclosed in many documents such as, for example, EP-A-1334742, EP-A-462701, EP-A-1985327 or EP-A-956069.

The shell or mask body 1 is fluidly linked to a gas supply line 17, such as a flexible hose, by means of the tubular hollow connector 16, which delivers a respiratory gas, such as air under pressure, into the breathing chamber 10 of the shell 1. The tubular connector 16 comprises one or several venting outlets, such a several holes, for venting to the atmosphere the CO₂-containing gases exhaled by the patient. The gas supply line 17 is fed with air under pressure by a respiratory device or ventilator (not shown).

Furthermore, the mask body 1 comprises a lodging in recess arranged in the upper part of the mask 1 body, i.e., between the gas inlet orifice 18 and the expansion part 2, in which an oxygen and measurement port 13, i.e., an oxygen connection, is arranged. A closing flap 14 closes the lodging when the oxygen port 13 is not used as shown in FIG. 1.

The nasal mask of the present invention can be used in a method for treatment of a respiratory disorder or condition, for example, in non-invasive positive pressure ventilation (NPPV) or in a nasal continuous positive airway pressure (N-CPAP) therapy of sleep disordered breathing (SDB) conditions, such as, for example, obstructive sleep apnea (OSA).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A respiratory mask comprising:
a mask body (1) with an internal chamber (10);
an expansion part (2) arranged on the mask body (1) and projecting upwardly from the mask body (1), the expansion part (2) comprising a traversing orifice (3);
the expansion part (2) and the mask body (1) being molded in one-piece so that the expansion part (2) is integral with the mask body (1);
a holding arm (4) pivotable around a first axis (AA) located on the mask body (1) or on the expansion part (2);
a forehead support (9) fixed to the holding arm (4) and pivotable around an axis (BB) located on the holding arm (4); and
an acting piece (5) mobile in the traversing orifice (3) of the expansion part (2), wherein the acting piece (5) cooperates with the holding arm (4) for pivoting the holding arm (4) around the first axis (AA) when the acting piece (5) moves in the traversing orifice (3) of the expansion part (2).

2. The respiratory mask of claim 1, wherein the mask further comprises a rotating knob (6) cooperating with the acting piece (5) for moving the acting piece (5) in the traversing orifice (3) when the rotating knob (6) is operated by a user.

3. The respiratory mask of claim 1, wherein the holding arm (4) is fixed to the expansion part (2) and pivotable around a first axis (AA) located on the expansion part (2).

4. The respiratory mask of claim 1, wherein the acting piece (5) acts on the holding arm (4) for changing its angular position around the first axis (AA).

5. The respiratory mask of claim 1, wherein the forehead support (9) pivots around a second axis (BB) arranged on the holding arm (4).

6. The respiratory mask of claim 1, wherein the rotating knob (6) comprises a first threading (7) cooperating with a second threading (8) arranged on the acting piece (5).

7. The respiratory mask of claim 1, wherein the holding arm (4) pivots around the first axis (AA) of 50° or less.

8. The respiratory mask of claim 1, wherein the forehead support (9) pivots around the second axis (BB) of 90° or less.

9. The respiratory mask of claim 1, wherein the expansion part (2) and the mask body (1) are each made of polymeric material.

10. The respiratory mask of claim 1, wherein the forehead support (9) comprises one or several pillows (11) of soft material.

11. The respiratory mask of claim 1, wherein the mask body (1) further comprises a gas inlet orifice (7) in fluid communication with the internal chamber (10), the internal chamber (10) further comprising a peripheral border (11) and a cushion (12) being fixed to the peripheral border (11), the cushion (12) having a central aperture for receiving at least part of the patient's nose.

12. The respiratory mask of claim 11, wherein the cushion (12) comprises one or several flexible membranes.

13. The respiratory mask of claim 1, wherein the threading (7) of the acting piece (5) comprises a restriction (23).

14. The respiratory mask of claim 1, wherein the mask further comprises a headgear and fixing means (19, 20) for fixing the headgear to the mask body (1).

15. The respiratory mask of claim 9, wherein the polymeric material is selected from polycarbonate, polypropylene, ABS, nylon or polystyrene.

16. The respiratory mask of claim 1, wherein the mask is a nasal mask.

17. The respiratory mask of claim 2, wherein the holding arm (4) is fixed to the expansion part (2) and pivotable around a first axis (AA) located on said expansion part (2).

18. The respiratory mask of claim 17, wherein the acting piece (5) acts on the holding arm (4) for changing its angular position around the first axis (AA).

19. The respiratory mask of claim 18, wherein the forehead support (9) pivots around a second axis (BB) arranged on the holding arm (4).

20. The respiratory mask of claim 19, wherein the rotating knob (6) comprises a first threading (7) cooperating with a second threading (8) arranged on the acting piece (5).

21. The respiratory mask of claim 20, wherein the holding arm (4) pivots around the first axis (AA) of 50° or less.

22. The respiratory mask of claim 21, wherein the forehead support (9) pivots around the second axis (BB) of 90° or less.

23. The respiratory mask of claim 22, wherein the expansion part (2) and the mask body (1) are made of polymeric material.

24. The respiratory mask of claim 23, wherein the forehead support (9) comprises one or several pillows (11) of soft material.

25. The respiratory mask of claim 24, wherein the mask body (1) further comprises a gas inlet orifice (7) in fluid communication with the internal chamber (10), the internal chamber (10) further comprising a peripheral border (11) and a cushion (12) being fixed to said peripheral border (11), the cushion (12) having a central aperture for receiving at least part of the patient's nose.

26. The respiratory mask of claim 25, wherein the threading (7) of the acting piece (5) comprises a restriction (23).

27. The respiratory mask of claim 26, wherein the mask further comprises a headgear and fixing means (19, 20) for fixing the headgear to the mask body (1).

28. The respiratory mask of claim 23, wherein the polymeric material is selected from polycarbonate, polypropylene, ABS, nylon or polystyrene.
